(19) United States
(12) Patent Application Publication
(10) Pub. No.: US 2007/0292342 A1
(43) Pub. Date: Dec. 20, 2007

(54) Synthesis gas production method and reactor

(76) Inventors: John William Hemmings, Katy, TX (US); Leo Bonnell, Houston, TX (US); Earl T. Robinson, Mentor, OH (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/454,884

(22) Filed: Jun. 19, 2006

(51) Int. Cl. C01B 3/26; B01J 12/00

(52) U.S. Cl. 423/651; 422/168

(57) ABSTRACT

A method of producing a synthesis gas from a hydrocarbon containing gaseous feed in which the hydrocarbon containing gaseous feed is reacted in an autothermal reactor having separated reaction stages in which partial oxidation and steam methane reforming reactions occur. Each of the reaction stages has alternating separation zones and catalytic reaction zones. Oxygen separated by oxygen ion transport in the separation zone supports the partial oxidation reactions occurring in the catalytic reaction zones. Reactants are separately metered to the reaction stages to control temperatures within the reaction stages so that use of expensive high temperature materials is confined to one or more final reaction stages. Reaction stages can incorporate perforated planar members with regions of oxygen ion transport membrane material in registry with such perforated regions form the separation zones and the catalytic reaction zones.

### U.S. GOVERNMENTAL INTEREST

This invention was made with United States Government support under Cooperative Agreement number DE-FC26-01NT41096 awarded by the U.S. Department of Energy, National Energy Technology Laboratory. The United States Government has certain rights in this invention.

### FIELD OF THE INVENTION

The present invention relates to a method and reactor for producing a synthesis gas product from a hydrocarbon containing gaseous feed in which reactant streams comprising the hydrocarbon containing gaseous feed and steam are subjected to partial oxidation reactions and steam methane reforming reactions within reaction stages of a reactor employing oxygen transport membrane elements to produce oxygen to support the partial oxidation reactions. More particularly, the present invention relates to such a method and reactor in which the reactant streams are metered to each of the reactors to control operational temperatures to minimize the use of high-temperature, expensive alloys within the reaction stages.

### BACKGROUND OF THE INVENTION

Synthesis gases that contain hydrogen and carbon monoxide are utilized in a wide variety of industrial applications. For example, the synthesis gas itself can be utilized as a fuel or can be purified to produce hydrogen and/or carbon monoxide products or can be further processed to produce other chemical products or to produce liquid fuels by, for example, Fischer-Tropsch reactions.

Synthesis gas is ordinarily produced by well known steam methane reforming reactions in which steam is reacted with hydrocarbons to produce a synthesis gas. In an alternative reaction, the hydrocarbons can be partially oxidized to produce the synthesis gas. A yet further alternative is a combination between the two reactions known as autothermal reforming in which partial oxidation and steam methane reforming reactions are combined. The partial oxidation reaction is exothermic and the heat generated can be used to support endothermic heating requirements for the steam methane reforming reaction. Partial oxidation alone and autothermal reforming both require a source of oxygen. The source of oxygen can advantageously be provided by an oxygen transport membrane that is incorporated into a partial oxidation reactor or an autothermal reactor.

An oxygen transport membrane is formed of a ceramic, typically, a perovskite. Such a ceramic is capable of conducting both oxygen ions and electrons. On one surface of the oxygen transport membrane, conventionally known as the cathode side, oxygen ionizes to produce oxygen ions. When the membrane is subjected to a driving force of an oxygen partial pressure differential, the oxygen ions are driven through the membrane and emerge from the other side to produce oxygen to react with the hydrocarbons in the partial oxidation reactions. The consumption of the oxygen in such reactions may be sufficient to produce the oxygen partial pressure differential. Recombination of the oxygen ions liberates electrons that are transported back through the membrane to ionize the oxygen.

It is to be noted that oxygen transport membranes in addition to mixed conductors, such as described above, can also be formed of a material having a metallic phase and a ceramic ionic phase. The ionic phase will function to solely conduct the oxygen ions and the metallic phase will conduct the electrons. Oxygen transport membranes can in fact incorporate all three phases, namely, an ionic phase, a mixed conducting phase and a metallic phase.

Typically, partial oxidation reactors and autothermal reactors incorporate catalysts that function to promote partial oxidation reactions and steam methane reforming reactions.

Oxygen transport membranes require high operation temperatures, typically between 400° C. and about 1200° C. in order to conduct oxygen ions. Additionally, as mentioned above, the steam methane reforming reaction, being endothermic, requires heat in order to sustain such reaction. However, at high operational temperatures, oxygen transport materials and supporting materials that are used to support the oxygen transport membrane can, over time, degrade and even fail by known creep mechanisms of failure.

Compounding this problem is that the oxygen flux developed by the oxygen transport membrane is dependent upon temperature. This creates a problem in either partial oxidation reactors or autothermal reforming reactors. The reason for this is that hydrocarbons tend to predominantly react with oxygen at the inlet of the reactor. This creates an uncontrolled temperature rise in the oxygen transport membrane material by consequential increases in oxygen flux and hydrocarbon consumption. This uncontrolled temperature rise is referred to as thermal run-away to also cause failure at the oxygen transport membrane. In autothermal reactors a further problem is that as steam methane reforming reaction proceed along the length of the reactor, the reactants become evermore dilute to reduce the degree of synthesis gas conversion below that which is theoretically possible. A still further problem is that at the high operating temperatures of reactors incorporating oxygen transport membranes, that higher order hydrocarbons tend to decompose and thereby form carbon deposits on catalysts employed within the reactor. Such deposits will eventually destroy the catalyst.

U.S. Pat. No. 6,695,983 attempts to solve high temperature problems associated with oxygen transport membranes. In this patent, a hydrocarbon containing feed is converted into a synthesis gas in two or more reactors. The initial reactor, that utilizes an oxygen transport membrane, operates at a lower temperature than a subsequent conventionally fired reactor. As a result, membrane failure problems associated with high operational temperatures can be avoided. The disadvantage is that the final stage utilizes an oxygen-fired autothermal reformer or an air fired steam reformer.

In yet another attempt to solve the high temperature problems associated with the use of oxygen transport membranes, U.S. Patent Application Pub. No. 2005/0061663 provides a composite that is supported by an oxide dispersed strengthened metal. Such materials are resistant to failure at high temperatures. The oxygen transport membrane supported on such metal can incorporate three phases, namely, a mixed conducting phase, an ionic phase and a metallic phase. The use of such a three-phase material helps to prevent thermal failures of the membrane and also, to help match the thermal coefficients of expansion between the oxide dispersed strengthened metal support and the membrane itself.

U.S. Pat. No. 6,402,988 discloses an autothermal reformer incorporating an oxygen transport membrane. In this patent, the exothermic reaction of the partial oxidation reaction, the endothermic reaction and the heat transfer between reactions are controlled to maintain the membrane within prescribed temperature limits and to promote catalytic activity along the length of the reaction path. This variation of catalyst activity also allows greater conversion rates towards the exit end of the reactor due to dilution of the feed caused by conversion.

U.S. Pat. No. 6,048,472 employs a prereformer operating at a lower temperature upstream of an oxygen transport membrane reactor to eliminate carbon formation.

The problem of employing staged reaction as described above is that a downstream conventional reactor is required in order to complete the conversion of the hydrocarbons to synthesis gas. The use of oxide dispersed strengthened metals has the drawback of expense. The use of prereformers to control carbon formation introduce expense and complexity to the facility.

As will be discussed, the present invention provides a method of producing a synthesis gas from a hydrocarbon containing feed in which a series of reactors are utilized in a manner in which temperatures can be controlled to allow for the strategic use of the more expensive, high-temperature alloys and also, to prevent damage to catalyst employed in the reactors by carbon deposition.

### SUMMARY OF THE INVENTION

In one aspect, the present invention provides a method of producing a synthesis gas product stream containing hydrogen and carbon monoxide. In accordance with the method, hydrocarbon containing reactant streams are reacted with oxygen and steam in partial oxidation reactions and in steam methane reforming reactions. These reactions are conducted within catalytic reaction zones located in the separate reaction stages to produce the synthesis gas product stream. The catalytic reaction zones are connected in series so that intermediate products produced by upstream catalytic reaction zones are introduced into downstream catalytic reaction zones as viewed with respect to a final catalytic reaction zone from which the synthesis gas product stream is discharged.

Oxygen is separated from an oxygen containing feed stream within separation zones, located within the reaction stages, with the use of oxygen transport membrane elements situated between the separation zones and the catalytic reaction zones. This allows the oxygen that is separated to be fed into the catalytic reaction zones to support the partial oxidation reactions. Heat is provided from the partial oxidation reactions to support endothermic heating requirements and the steam methane reforming reactions and operational temperature requirements of the oxygen transport membrane elements.

The temperature is controlled within the catalytic reaction zones by metering the reactant streams so that at least the final of the catalytic reaction zones, from which the synthesis gas product stream is discharged, operates at a temperature range of between about 900° C. and about 1100° C. and at least one catalytic reaction zone located upstream of the final of the catalytic reaction zones has an operational temperature below the temperature range. There are a sufficient number of reaction stages such that at least about 95 percent of the hydrocarbon content of the reactant streams is converted to the synthesis gas. In this regard by metering the reactant streams the flow rate of each such stream is controlled. This does not mean, however, that all streams are fed to each stage; and, in fact as in the example below, there may be no stream fed to the final stage or stages.

By independently controlling the temperature within the catalytic reaction zones, upstream reaction stages can be constructed from less expensive and conventional high temperature alloys where final reaction stages that operate at high temperature can be fabricated from more expensive materials such as an oxide dispersed strengthened metal. This arrangement minimizes the use of the more expensive high temperature materials. In this regard, the oxygen transport membrane elements comprise metallic supports and oxygen transport membrane materials supported by the metallic supports. The metallic supports utilized in the at least the final of the reaction stages from which the synthesis gas stream is discharged can be fabricated from the oxide dispersed strengthened metal. The metallic supports of the oxygen transport membrane elements of at least one of the reaction stages located upstream of the at least the final of the reaction stages are fabricated from a high temperature metallic material that does not constitute the oxide dispersed strengthened metal. Furthermore, a final of the oxygen containing streams fed to the final of the reaction stages can be compressed to reduce pressure differential between the separation zones and the catalytic reactant zones located within the final of the reactant stages. This also will help decrease the use of the more expensive high temperature materials such as oxide dispersed strengthened metals by decreasing the mechanical stresses induced by the pressure differential.

In a preferred embodiment, there can be provided five of such reaction stages. In any embodiment of the present invention, the oxygen containing streams and the reactant streams can flow within the reaction stages in a cross-flow relationship.

In order to reduce carbon formation and possible catalyst poisoning, a hydrogen containing stream and a first steam stream can be combined with a portion of a hydrocarbon containing feed to produce a first of the reactant streams. The first of the reactant streams is fed to a first of the catalytic reaction zones. A second steam stream is combined with the remaining portion of the hydrocarbon containing gaseous feed to produce the remainder of the reactant streams fed to the catalytic reaction zones located downstream of the first of the reaction stages. The steam to carbon ratio can be controlled within the first of the catalytic reaction zones to help prevent solid carbon formation by metering the first steam stream. The hydrogen containing stream can be made up of recycled Fisher-Tropsch tail gas.

The foregoing allows the reactor to operate with a high steam to carbon ratio, or with an abundance of hydrogen present throughout the reactor so as to avoid carbon lay down. Carbon is laid down by various reactions including the decomposition of methane to carbon and hydrogen. The carbon can be removed by reaction of the carbon with hydrogen and with steam to produce carbon monoxide and additional hydrogen. These reactions, as well as other reactions that occur between carbon monoxide, carbon dioxide, carbon, methane, steam and hydrogen, are essentially equilibrium reactions. As such, the reactions can be driven in the reverse direction by maintaining a sufficient partial pressure of steam and/or hydrogen in all of the reaction stages. If a hydrocarbon containing reactant is added in stages to a fixed amount of steam, these ratios can be kept on the safe side, namely, away from carbon lay down. In this regard, initially the steam to carbon ratio is high as only a portion of the hydrocarbons to be reacted is added to all of the steam. As the reactions proceed, hydrogen is manufactured, so when additional tranches of feed stock are added to the reaction stages, which drives down the steam to total carbon ratio, the presence of hydrogen helps protect against carbon lay down. Consequently the addition of hydrocarbons can be arranged in such manner that the process stream remains out of the carbon lay down region.

The present invention in another aspect provides a reactor for reacting a hydrocarbon containing reactant stream with oxygen and steam to produce a synthesis gas product stream. In accordance with this aspect of the present invention, the reactor employs a plurality of separate reaction stages for reacting the hydrocarbon containing reactant stream with oxygen and steam in partial oxidation reactions and in steam methane reforming reactions to produce the synthesis gas product stream.

The reaction stages contain catalytic reaction zones having a catalyst to promote the partial oxidation reactions. The catalytic reaction zones are connected in series. Additionally, separation zones are located adjacent to the catalytic reaction zones and oxygen transport membrane elements are situated between the separation zones and the catalytic reaction zones to separate oxygen from an oxygen containing gas to support the partial oxidation reactions occurring within the catalytic reaction zones.

Each of the reaction stages has a housing to contain the catalytic reaction zones, the separation zones and the oxygen transport membrane elements. The housing can have an oxygen gas inlet to introduce the oxygen containing gas into the separation zones, a retentate outlet to discharge an oxygen depleted retentate from the separation zones, a reactant inlet to introduce reactant into the catalytic reaction zones and a product outlet to discharge product produced from the partial oxidation reactions and the steam methane reforming reactions.

The oxygen transport membrane elements have metallic supports and oxygen transport membrane materials supported by the metallic supports. The metallic supports of the oxygen transport membrane elements of at least a final of the reaction stages, from which the synthesis gas product is discharged, are fabricated from oxide dispersed strengthened metal and the metallic supports of the oxygen transport membrane elements of at least one of the reaction stages located upstream of the at least the final of the reaction stages are fabricated from a high temperature metallic material that does not constitute the oxide dispersed strengthened metal.

Preferably, each of the reaction stages are formed by planar members spaced apart and connected to one another to define the catalytic reaction zones and the separation zones on opposite sides of the planar members. The planar members have porous regions and oxygen transport membrane materials located on the porous regions, thereby to form the oxygen transport membrane elements with the planar members serving as the metallic supports. Each of the reaction stages can have catalytic reaction zones alternating with the separation zones with pairs of spaced planar members forming the oxygen transport membrane elements being located between the catalytic reaction zones and the separation zones being located between the pairs of spaced planar members. Preferably, supports separate the pairs of the planar members and even more preferably, the supports for the pairs of spaced planar members forming the oxygen transport membrane elements are of serpentine configuration.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a schematic process flow diagram of a method in accordance with the present invention;

FIG. 2 is a fragmentary view of FIG. 1 illustrating an alternative embodiment thereof;

FIG. 3 is a perspective view of a reactor in accordance with the present invention;

FIG. 4 is a sectional view taken along line 4-4 of FIG. 3;

FIG. 5 is a sectional view taken along line 5-5 of FIG. 3;

FIG. 6 is a bottom plan view of a flow distributor of the present invention;

FIG. 7 is an enlarged fragmentary view of FIG. 4;

FIG. 8 is a fragmentary view taken along line 8-8 of FIG. 7; and

FIG. 9 is an enlarged fragmentary schematic, sectional view of FIG. 7 illustrating the structure of the oxygen transport membrane.

### DETAILED DESCRIPTION

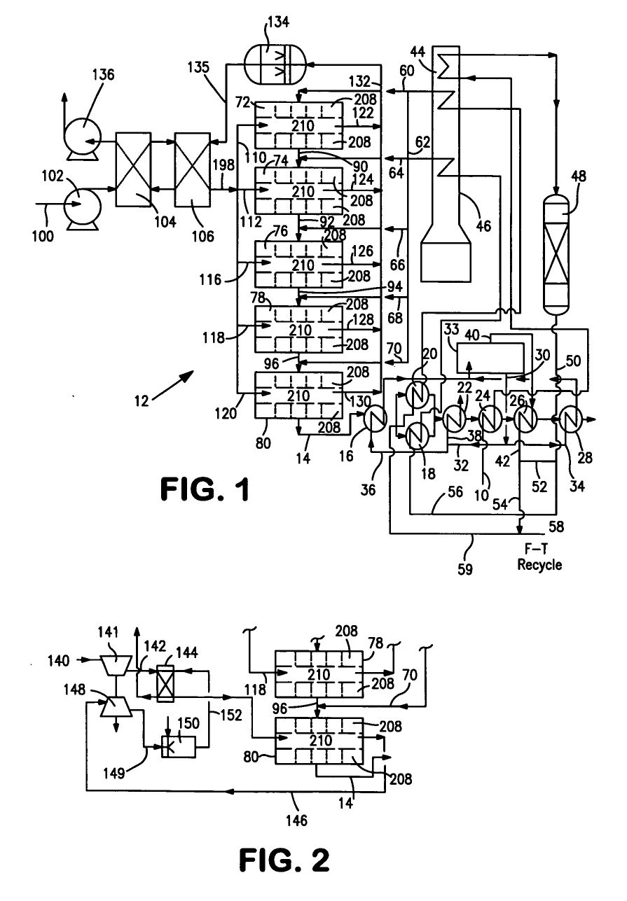

With reference to FIG. 1, a process flow diagram is illustrated for producing hydrogen from a hydrocarbon containing gaseous feed which can be a natural gas feed stream 10. Natural gas feed stream 10 is processed within a reactor 12 to produce a synthesis gas product stream 14.

Reactor 12 is employed in a heat transfer and steam generation environment of a type that is employed in connection with conventional steam methane reformers and autothermal reformers. In this regard, synthesis gas product stream 14 is cooled by passage through waste heat boiler 16, mixed feed heaters 18 and 20, a waste heat boiler 22, a natural gas preheater 24, a super heater 26 and a waste heat boiler 28. Steam stream 30 is divided into subsidiary steam streams 32 and 34. Subsidiary steam stream 32 is further divided into portions 36 and 38. Portion 38 passes through waste heat boiler 22 for export and portion 36 passes waste heat boiler 16 and is returned to steam drum 33. Subsidiary steam stream 34 passes through waste heat boiler 28 and is also redirected to steam drum 33. Steam drum 33 discharges a superheated steam stream 40 that passes through preheater 26 and forms a process steam stream 42.

Natural gas feed stream 10 is pretreated by a hydrotreater, not illustrated, to convert sulfur species contained within the natural gas to hydrogen sulfide. Natural gas feed stream 10 having been treated in such manner is passed through natural gas preheater 24 and sent to a convective section 44 of fired heater 46. The resultant heated natural gas feed stream 10 is then directed to a zinc oxide bed 48 for removal of the hydrogen sulfide to produce a treated stream 50.

The process steam stream 42 is divided into subsidiary process steam streams 52 and 54. Subsidiary process steam stream 52 is combined with treated stream 50 and is heated within feed heater 18. The resultant combined stream 56 is then passed into convective section 44 of fired heater 46.

Subsidiary process steam stream 54 is combined with a Fischer-Tropsch recycle stream 58 to produce a combined stream 59 which is preheated within mixed feed heater 20 and then finally heated in convective section 44 of fired heater 46. Preferably, the flow of subsidiary steam stream 54 is selected so that most of the steam from process stream 42 is combined with Fischer-Tropsch recycle stream 58 that contributes hydrogen which will allow for higher operational temperatures without carbon deposition. Combined stream 56 is subdivided into reactant streams 62, 64, 66, 68 and 70. Reactant stream 62 is combined with combined stream 59 to produce a combined reactant stream 60 that is fed into a reaction stage 72 of reactor 12. The steam to carbon ratio in reactant stream 60 is preferably between about 1.5 and about 2.0. This high steam to carbon ratio together with the contributed hydrogen will prevent carbon lay down in reaction stage 72. Additional hydrogen produced in this stage and in subsequent stages will also protect the subsequent stages from carbon deposition as outlined above. Reactant streams 64, 66, 68 and 70 are fed into reaction stages 74, 76, 78 and 80, respectively, also included in reactor 12. It is understood more or less said stages could be employed in a reactor in accordance with the present invention.

Each of the reaction stages 72, 74, 76, 78 and 80 has catalytic reaction zones 208 and separation zones 210. Combined reactant stream 60 and reactant streams 64, 66, 68 and 70 are subjected to partial oxidation and steam methane reforming reactions within catalytic reaction zones 208. As will be discussed, in practice there are several of such catalytic reaction zones 208 employed within each of the reaction stages 72, 64, 76, 78 and 80

Reaction stages 72, 74, 76, 78 and 80 are connected in series so that respective intermediate product streams 90, 92, 94 and 96 are produced that have a successively greater synthesis gas content. Aside from reaction stage 72, reactant streams 64, 66, 68 and 70 are combined with intermediate product streams 90, 92, 94 and 96 to serve as reactants fed to catalytic reaction zones 208.

Separation zones 210 are separated from the catalytic reaction zones 208 by oxygen transport membrane elements (to be discussed) that are capable of conducting oxygen ions at elevated temperatures occurring within the catalytic reaction zones 208. An oxygen containing stream that can be an air stream 100 is forced by a fan 102 through heat exchangers 104 and 106. This produces a heated air stream 198 that is subdivided into subsidiary air streams 110, 112, 116, 118 and 120 that are in turn fed into the separation zones 210 of the individual reaction stages 72, 74, 76, 78 and 80 to separate oxygen and thereby produce oxygen within the catalytic reaction zones 208. The oxygen reacts with hydrocarbons within the reactant streams 60, 64, 66, 68 and 70 to partially oxidize hydrocarbons and thereby to produce heat to support the steam methane reforming reactions and the elevated temperatures required by the oxygen transport membranes to separate the oxygen.

The separation produces retentate streams, depleted in oxygen, that are designated by reference numerals 122, 124, 126, 128 and 130. The retentate streams are combined into a combined retentate stream 132 that are passed into a duct fired heater 134. The resultant heated stream 135 is drawn through heat exchangers 106 and 104 by an induced draft fan 136.

Temperature within each of the reaction stages 72, 74, 76, 78 and 80 is controlled. The temperature in each of the catalytic reactor sections 208 is dependent upon the ratio of the oxygen to the reactants that are available for reaction. Increasing such ratio will increase the temperature and decreasing the ratio will decrease the temperature. As indicated above, the control of temperature is important in order to allow ceramic membranes to function and to allow some of the reaction stages to be fabricated with inexpensive materials. This temperature control is provided by controlling or metering the flow of the combined reactant stream 60 and the other reactant streams 64, 66, 68 and 80. Flow control can be provided through appropriate pipe sizing. More sophisticated control can be provided by valves and temperature controllers reacting to temperature sensed within reaction stages 72, 74, 76, 78 and 80. However, the control to be accomplished is based upon the amount of reactant within the reaction stage. Within limits too much reactant will tend to lower temperature and too little reactant will tend to increase the temperature.

Preferably, these temperatures are controlled to be in a range of between about 650° C. and below about 900° C. to allow temperature critical components of reaction stages 72, 74 and 76 to be fabricated from relatively inexpensive high temperature alloys such as INCONEL® 693 alloy or HAYNES 214 alloy. Oxide dispersed strengthened metals can be utilized in reaction stages 78 and 80 or at least reaction stage 80 that operate at high temperature of between about 900° C. and about 1100° C. As such, the more expensive oxide dispersed strengthened metals do not have to be used throughout the reactor 12.

The temperature of the final reactor stage 80 can be at an operating temperature that closely approaches an equilibrium temperature necessary for the conversion of substantially all the methane and other hydrocarbons fed to such stage through reactant stream 70 and intermediate product stream 96 to be converted to synthesis gas and such stage preferably operates at a temperature of approximately 950° C. to 1000° C. and at a pressure of about 30 bar. The initial or first of the reaction stages 72 operates at between about 600° C. and about 700° C. The temperature increases monotonically through reaction stages 74, 76 and 78. In all cases reaction stage 72 will operate a temperature which is in the capability of conventional alloys, while reaction stage 80 will invariably require high temperature alloy such as an oxide dispersed strengthened metal. The metallurgy required for stages 74, 76 and 78 will depend upon the operational temperatures employed, namely a temperature requiring a conventional alloy or the high temperature alloy of reaction stage 80. In all cases, however, there are a sufficient number of total reaction stages that about 95 percent of the hydrocarbon content of the feed is converted into synthesis gas.

As indicated above, natural gas stream 10 or process steam stream 42, Fischer-Tropsch recycle stream 58 are all at pressure and as such, reactant streams 60, 62, 64, 66, 68 and 70 are also preferably at high pressure, for example 30 bar. This creates a pressure differential within the reaction stages and specifically on opposite sides of the oxygen transport membrane elements. The effects of the pressure differential are most severe for final reaction stage in the series, namely, reaction stage 80 that operates at the highest temperature. Since reaction stage 80 will use the most expensive, creep-resistant material, it is desirable to decrease resulting material stresses in such stage and thereby decrease the thicknesses and therefore the amounts of such material.

In order to reduce material stresses induced by pressure differential and temperature within high temperature reaction stages, such as reaction stage 80, arrangements such as shown in FIG. 2 can be used. In such embodiment, air stream 140 is compressed in a compressor 141 to form a compressed air stream 142 which is preheated within a heat exchanger 144. After preheating, compressed air stream 142 is introduced into separation section 210 of reaction stage 80. This produces a retentate stream 146 that is expanded in a turboexpander 148. The resultant expanded stream 149 is introduced into a duct fired heater 150 to produce a heated stream 152 that is used to heat the incoming compressed air stream 142 in a heat exchanger 144. In this embodiment, the combined retentate stream 132 is therefore not formed by retentate 130 which is not present in this embodiment. As such, the combined retentate stream 132 in the embodiment of FIG. 2 is formed by retentate streams 122, 124, 126 and 130. In all other respects, the embodiments of FIG. 2 functions in the same manner as described with respect to FIG. 1.

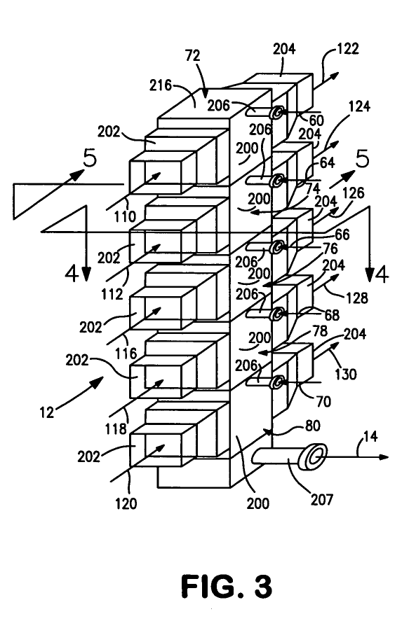

With reference to FIG. 3, reactor 12 is illustrated in more detail and in connection with its use in FIG. 1. Each of the reaction stages 72, 74, 76, 78 and 80 are provided with a housing 200 having an oxygen gas inlet 202 for subsidiary oxygen containing streams 110, 112, 116, 118 and 120. Additionally, retentate outlets 204 are provided for discharging retentate streams 122, 124, 126, 128 and 130. Reactant streams 60, 64, 66, 68 and 70 are introduced into reaction stages 72, 74, 76, 78 and 80 through reactant inlets 206. Synthesis gas product stream 14 is discharged from a reactor outlet 207.

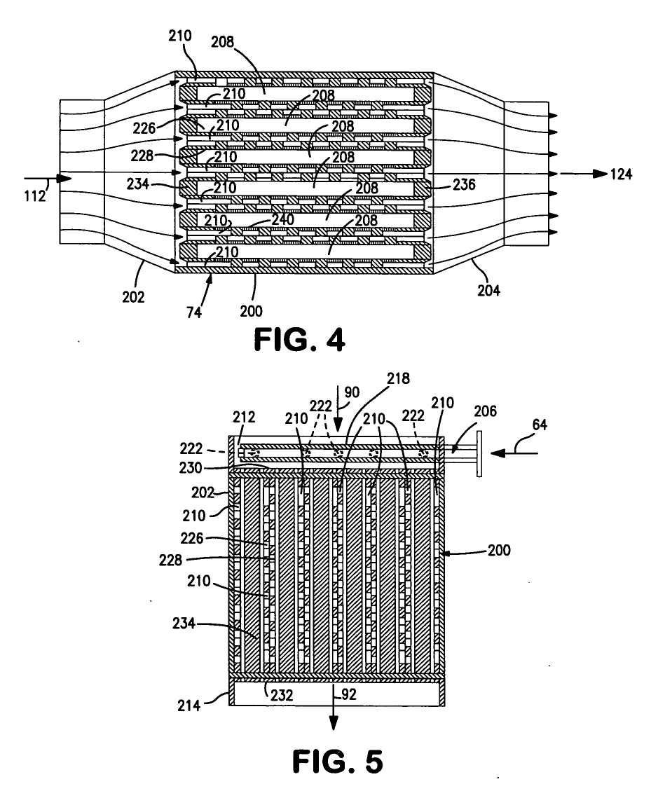

With reference to FIGS. 4 and 5 the internals of reaction stage 74 are illustrated. Reaction stages 72, 76, 78 and 80 would be identical in layout with, as stated above, different materials used in fabricating the same.

Reaction stage 74 has catalytic reaction zones 208 alternating with oxygen separation zones 210. Catalytic reaction zones 208 can contain catalyst, similar to conventional secondary reforming catalyst, for example in the form of nickel supported on alumina to promote the steam reforming reactions. Subsidiary oxygen containing stream 112 after having entered oxygen containing gas inlet 202 flows through the oxygen separation zones 210 in which oxygen separated from the subsidiary oxygen containing gas stream 112 by oxygen transport membrane elements (to be discussed hereinafter) to produce a retentate that is discharged as retentate stream 124. The separated oxygen permeates through the oxygen transport membrane elements to the catalytic reaction zones 208 to support the partial oxidation reactions. The heat generated from the partial oxidation reactions supports the endothermic heating requirements of the steam methane reforming reactions occurring within catalytic reaction zones 208 to produce intermediate product stream 92 that is discharged to downstream reaction stage 76.

The reactant stream 64, together with the intermediate product stream 90 produced in reaction stage 72, is introduced into an inlet plenum portion 212 of housing 200 and intermediate product stream 92 is discharged from an outlet plenum portion 214 of housing 200. Inlet plenum portion 212 is attached to the outlet plenum portion 214 of reaction stage 72. Outlet plenum portion 214 is attached to the inlet plenum portion 212 of reaction stage 76. For such purposes, inlet plenum portion 212 and outlet plenum portion 214 of reaction stages 74, 76 and 78 are open to allow for the flow of intermediate product, for example intermediate product stream 90 and intermediate product stream 92.

Housing 200 of reaction stage 72 has a top wall 216 (illustrated in FIG. 3) that closes off the top of its inlet plenum 212. Reaction stage 80 while having an open inlet plenum 212 has an enlarged closed outlet plenum 214 having a bottom wall to close it off that is not visible in the illustration.

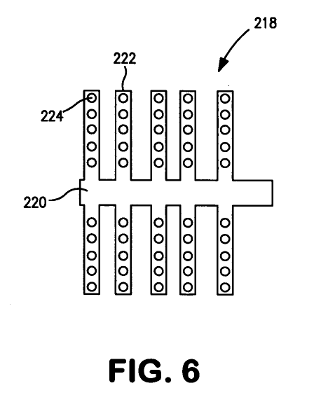

With reference to FIG. 6, reactant stream 64 enters reactant inlet 206 that is connected to a gas distributor 218 having a central conduit 220 and branch-like conduits 222 connected to central conduit 220. Branch-like conduits 222 are provided with openings 224 to expel individual streams of reactant gas stream 64 into reaction sections 208. Although not illustrated, a similar arrangement would be employed for a reaction section 80 to expel the synthesis gas product, except that the branched gas distributor 218 thereof would be rotated 180 degrees and connected to synthesis gas outlet 207.

With continued reference to FIGS. 4 and 5, the oxygen separation zones 210 are formed of pairs of planar members 226 and 228 respectively. Each of the pairs of planar members 216 and 218 are sealed at the top and bottom (as viewed in FIG. 5) by provision of sealing strips 230 and 232, respectively, that are welded to opposed top and bottom edges thereof. Separating the oxygen separation zones 210 are pairs of opposed elongated members 234 and 236. These members are welded along opposed edge portions of the pairs of planar members 226 and 228. Along the walls of housing 200, single planar members 228 and 226 are utilized to form the separation zones 210. The separation zones 210, generally speaking, are therefore formed between pairs of planar members 226 and 228 and by the elongated members 234 and 236. As a result, the flow of reactants versus the oxygen containing gas is in a cross-flow relationship.

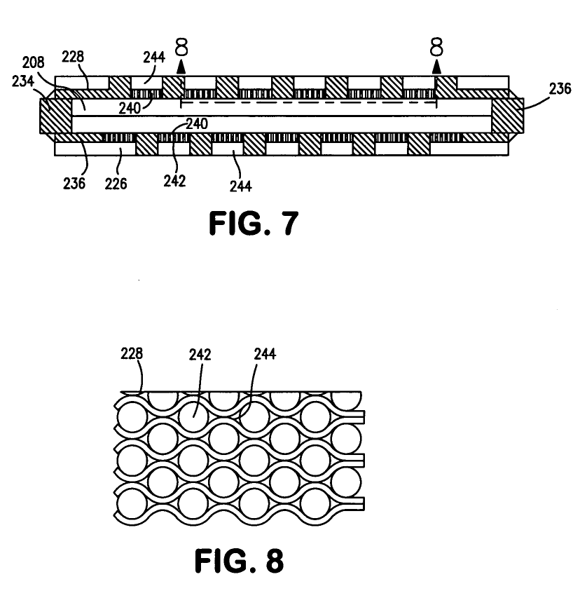

With additional reference to FIGS. 7 and 8 each of the planar members 228 and 226 has porous regions 240 and oxygen transport membrane materials 242 in registry with porous regions 240. Thus, each of the planar members, either 236 or 228, form oxygen membrane elements with the oxygen transport materials 242 supported by such planar members 236 or 228 at the porous regions 240 thereof. In order to insure structural integrity, and also to help direct the flow, a serpentine arrangement of supports 244 are provided that enclose the oxygen transport materials 242.

As discussed above the control of temperature allows planar members 228 and 236 of reaction stage 80 to be made of the more expensive high temperature materials, for instance, oxide dispersed strengthened metal as opposed to the upstream reaction sections 72, 74, 76 and 78 which can all be made out of a less expensive, high temperature alloy, can be formed of an oxide dispersed strengthened metal alloy to reliably function at high temperatures of up to 1200° C. Such metal alloys contain aluminum, chromium, and iron and yttrium oxide and can be obtained as MA956 alloy from Special Metals Corporation, Huntington, W. Va., United States or PM2000 alloy from Plancee Holding AG, an Austrian corporation having a place of business at A-6600 Reutte/Tirol Austria. Other possible materials are metal-reinforced intermetallic alloys, for example, Nb-reinforced Nb.sub.3Al (Nb/Nb.sub.3Al), Nb or TiNb/TiAl, Mo or Cr/NiAl, Nb/MoSi.sub.2, Boron-doped Mo.sub.5Si.sub.3-based intermetallic alloys and combinations thereof. Ceramic materials include, yttria toughened zirconia (such as Y-TZP, ZrO.sub.2-3% Y.sub.2O.sub.3), ceria toughened zirconia (such as Ce-TZP, ZrO.sub.2-xCeO.sub.2), or gadolinium doped ceria. All of the alloys and ceramics have attractive high temperature properties including good creep resistance and superior mechanical strength. These materials also have high fracture toughness.

The proceeding reaction stages 72, 74, 76 and 78 can be fabricated from less expensive high temperature alloys, discussed above. It is to be noted that the walls of the reactor stages formed by housing 200 of any reactor stage need not in any case be constructed of high temperature materials in that they are exposed to the ambient temperature and heat will thereby dissipate into the ambient environment.

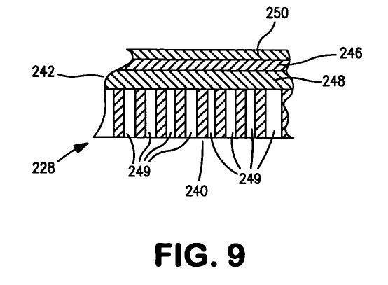

With reference to FIG. 9, an illustrative structure of planar member 228 is illustrated. Planar member, on its exterior surface, is provided with circular regions of oxygen transport membrane materials 242 that overlie and are in registry with porous regions 240. Each of the circular regions of the oxygen ion membrane materials has a dense layer 246 applied to a porous layer 248 that is in turn applied to planar member 228. Porous regions 240 each have a set of cylindrical or slightly conical pores 249 that can be formed by known electron beam drilling techniques. Such pores can taper from about 150 microns to about 75 microns. Porous layer 248, located between dense layer 246, and planar member 228 helps to at least distribute separated oxygen from dense layer 246 to the cylindrical pores 249 within porous regions 240. For such purposes the pores of porous layer 248 are interconnected. Both dense layer 246 and porous layer 248 can be composed of a material capable of conducting both oxygen ions and electrons such as will be discussed below.

Dense layer 246 is preferably a mixture of three phases containing a mixed conductor, an ionic conductor and a metallic electronic conductor can contain about 40 percent by weight “LSFT” (La_{0.2}Sr_{0.8}Fe_{0.6}Ti_{0.4}O₃), 40 percent by weight “CGO” (Ce_{0.8}Gd_{0.2}O), and about 20 percent by weight silver. Porous layer 248 can be similarly formed. The difference between the coefficient of thermal expansion of such material over a MA956 oxide disbursed strengthened metal is less than 1 ppm/° K. over the range of about 100° C. to about 1000° C. The proportions would be adjusted for upstream stages formed of high temperature alloys in a manner known in the art.

The material for the dense layer 246 and the porous layer 248 can be prepared by first obtaining about 40 grams of LSFT powder having particle sizes of between about 20 and about 30 microns agglomerated from primary particle sizes of between about 0.3 microns and about 0.5 microns, 40 grams of CGO powder having particle sizes of between about 20 and about 30 microns agglomerated from primary particle sizes of between about 0.5 and about 0.6 microns, and 20 grams of silver powder with particle size of between about 2 and about 3 microns. The foregoing components can be placed into a plastic vial with a few mixing zirconia balls. The powder mixture can then be ball milled for 20 minutes.

Dense layer 246 and a porous layer 248 can be applied to porous regions 240 of planar member 228 by plasma spraying with standard deposition conditions. Porous layer 248 can have a thickness of about 80 microns. The porosity within the porous layer 248 can be achieved using the above three-component mixed powder blended with 40 percent by weight of graphite having average particles size of 75 microns. The dense layer 246 can then be applied to porous layer 248. The thickness of dense layer 246 is preferably about 150 microns.

In order to prevent silver evaporation at high temperature, an additional thin porous layer 250 with a thickness of less than about 20 microns of LSFT coating containing no silver addition can be plasma sprayed on the surface of dense layer 246. This porous LSFT coating can be obtained by spraying the above LSFT powder mixed with 40 percent weight graphite having average particle size of 75 microns.

The following is a calculated example of a reactor 12 utilized within the environment of FIG. 1. For purposes of this example, 36 parallel stacks of 5 reaction stages each were used, 50 planar members 226 and 228 were employed in each reaction stage. Each planar member 226 and 228 was assumed to have approximately 30,000 regions of oxygen transport membrane materials 242 to provide a total area of about 810 to 1350 ft² and a total oxygen flux of about 0.025 to 0.03 STPD/ft². The following table summarizes the result:

| Natural | | | | | | | | | |
|---|---|---|---|---|---|---|---|---|---|
| Gas | F-T | Combined | Combined | Reactant | Intermediate | Intermediate | Intermediate | Intermediate | Synthesis |
| Feed | Recycle | Steam | Reactant | Streams | Product | Product | Product | Product | Gas |
| Stream | Stream | Stream | Stream | 64, 66, | Stream | Stream | Stream | Stream | Product |
| 10 | 58 | 42 | 60 | 68, & 70 | 90 | 92 | 94 | 96 | Stream 14 |

Component flowrates, lbmol/hr

| | | | | | | | | | | |
|---|---|---|---|---|---|---|---|---|---|---|
| H2 | 0.0 | 1554.9 | 0.0 | 2516.0 | 0.0 | 13390.8 | 25865.8 | 38240.6 | 49669.3 | 58175.0 |
| H2O | 0.0 | 59.0 | 18621.4 | 9189.5 | 8524.3 | 9279.6 | 11938.7 | 14928.2 | 17251.4 | 19140.4 |
| CO | 0.0 | 23.8 | 0.0 | 218.3 | 0.0 | 4728.3 | 10076.7 | 15177.7 | 20570.6 | 26221.0 |
| CO2 | 405.2 | 1703.7 | 0.0 | 2144.3 | 350.6 | 3161.3 | 4101.2 | 5225.7 | 5818.0 | 5365.3 |
| METHANE | 25804.3 | 2557.6 | 0.0 | 7013.1 | 22328.1 | 1641.0 | 3700.2 | 6982.2 | 6813.4 | 1617.1 |
| ETHANE | 351.2 | 76.5 | 0.0 | 47.5 | 303.9 | 0.1 | 0.3 | 0.7 | 0.6 | 0.1 |
| N2 | 318.3 | 1475.4 | 0.0 | 1518.3 | 275.4 | 1518.3 | 1615.4 | 1726.0 | 1793.7 | 1793.7 |
| O2 | 0.0 | 0.0 | 0.0 | 0.0 | 0.0 | 0.0 | 0.0 | 0.0 | 0.0 | 0.0 |
| C2H4 | 0.0 | 17.6 | 0.0 | 0.0 | 0.0 | 0.0 | 0.1 | 0.2 | 0.2 | 0.1 |
| C3H8 | 102.0 | 104.0 | 0.0 | 13.7 | 88.3 | 0.0 | 0.0 | 0.0 | 0.0 | 0.0 |
| C4H10 | 35.1 | 87.0 | 0.0 | 4.7 | 30.4 | 0.0 | 0.0 | 0.0 | 0.0 | 0.0 |
| C5H12 | 0.0 | 60.8 | 0.0 | 0.0 | 0.0 | 0.0 | 0.0 | 0.0 | 0.0 | 0.0 |
| C6H14 | 0.0 | 56.0 | 0.0 | 0.0 | 0.0 | 0.0 | 0.0 | 0.0 | 0.0 | 0.0 |
| C7H16 | 0.0 | 0.0 | 0.0 | 0.0 | 0.0 | 0.0 | 0.0 | 0.0 | 0.0 | 0.0 |
| C8H18 | 0.0 | 9.0 | 0.0 | 0.0 | 0.0 | 0.0 | 0.0 | 0.0 | 0.0 | 0.0 |
| CARBON | 0.0 | 0.0 | 0.0 | .0 | 0.0 | 0.0 | 0.0 | 0.0 | 0.0 | 0.0 |
| Temperature, | 21.0 | 99.4 | 350.0 | 584.4 | 621.0 | 871.1 | 871.1 | 871.1 | 897.0 | 986.9 |
| deg C. | | | | | | | | | | |
| Pressure, | 350.0 | 340.0 | 690.0 | 340.0 | 350.0 | 340.0 | 340.0 | 340.0 | 340.0 | 340 |
| psia | | | | | | | | | | |
| Flowrate, | 27016.1 | 7785.3 | 18621.4 | *Note | *Note | 33719.5 | 57298.4 | 82281.3 | 101917.3 | 112153.2 |
| lbmol/h | | | | | | | | | | |

*Note: The flow rate for combined reactant stream 60 was about 22665.5 lbmol/h; the flow rate for reactant stream 64 was about 11250 lbmol/h; the flow rate for reactant stream 66 was about 12813.5 lbmol/h; the flow rate for reactant stream 68 was about 5743.5 lbmol/h; and the flow rate for reactant stream 70 was about 0 lbmol/h. A further note is that the oxygen containing streams 110, 112, 116, 118 and 120 were all assumed to be air having a temperature of about 662.8° C., a pressure of about 17 psi absolute and a flow rate of about 105606 lbmol/h.

Note that in this example case, the staged reactant streams have been arranged such that the outlet temperature from each of the first four stages is approximately 871° C., while the outlet temperature from the final stage is approximately 982° C. This is done to maximize the productivity of upstream stages by maintaining as high a temperature as possible (and consequently as high an oxygen flux as possible) consistent with the material properties. The final reaction stage employs oxide dispersed strengthened material and operates at a higher outlet temperature to secure sufficient conversion of methane.

It is to be further pointed out that the prior art has provided examples of oxygen transport membrane reactors that are capable of conducting autothermal reforming reactions. Such reactors can incorporate tubular oxygen transport membrane elements and are in any case different from reactor 12 described in detail hereinabove. As could be appreciated by those skilled in the art, such reactors could be linked together in a manner in which each reactor would function as a reaction stage in a manner that would at least enable a process of the present invention to be conducted. Furthermore, a reactor 12 could be constructed that would utilize a single dense layer on a planar porous support as opposed to the structure outlined above having an underlying porous layer 248 with interconnected pores and an overlying layer 250 to prevent silver evaporation. As could be appreciated, an oxygen transport membrane element having such structure would not incorporate the efficiency and potential longevity of the structure specifically described herein.

While the present invention has been described with reference to a preferred embodiment, as will occur to those skilled in the art, other changes, additions and omissions may be made without departing from the spirit and scope of the present invention as set forth in the appended claims.

We claim:

1. A method of producing a synthesis gas product stream containing hydrogen and carbon monoxide, said method comprising:
reacting hydrocarbon containing reactant streams with oxygen and steam in partial oxidation reactions and in steam methane reforming reactions conducted within catalytic reaction zones located in separate reaction stages to produce the synthesis gas product stream, the catalytic reaction zones being connected in series;
separating oxygen from an oxygen containing feed stream within separation zones, located within the reaction stages, with the use of oxygen transport membrane elements situated between the separation zones and the catalytic reaction zones so that the oxygen is fed into the catalytic reaction zones to support the partial oxidation reactions and heat is provided from the partial oxidation reactions to support endothermic heating requirements of the steam methane reforming reactions and operational temperature requirements of the oxygen transport membrane elements; and
controlling temperature within the catalytic reaction zones by metering the reactant streams so that at least a final of the catalytic reaction zones, from which the synthesis gas product stream is discharged, operates at a temperature range of between about 900° C. and about 1100° C. and at least one catalytic reaction zone located upstream of the final of the catalytic reaction zones has an operational temperature, below said temperature range, there being a sufficient number of reaction stages such that at least about 95 percent of the hydrocarbon content of the reactant streams is converted to the synthesis gas.

2. The method of claim 1 wherein:
the oxygen transport membrane elements comprise metallic supports and oxygen transport membrane material supported by the metallic supports;
the metallic supports utilized in the at least the final of the reaction stages from which the synthesis gas stream is discharged are fabricated from an oxide dispersed strengthened metal; and
the metallic supports of the oxygen transport membrane elements of at least one of the reaction stages located upstream of the at least the final of the reaction stages are fabricated from a high temperature metallic material not constituting the oxide dispersed strengthened metal.

3. The method of claim 2, wherein a final of the oxygen containing streams fed to the final of the reaction stages is compressed to reduce pressure differential between the separation zones and the catalytic reactant zones located within the final of the reactant stages.

4. The method of claim 1, wherein the oxygen containing streams and the reactant streams flow within the reaction stages in a cross-flow relationship.

5. The method of claim 1, wherein:
a hydrogen containing stream and a first steam stream is combined with a portion of a hydrocarbon containing gaseous feed to produce a first of the reactant stream;
the first of the reactant stream being fed to a first of the serially connected catalytic reaction zones;
a second steam stream is combined with a remaining portion of the hydrocarbon containing gaseous feed to produce a remainder of the reactant streams fed to the serially connected catalytic reaction zones located downstream of the first of the reaction stages; and
a steam to carbon ratio is controlled within the first of the catalytic reaction zones to prevent solid carbon formation by metering the first steam stream.

6. The method of claim 5, wherein the hydrogen containing stream is made up of a recycled Fischer-Tropsch tail gas.

7. The method of claim 1, wherein there are five of the reaction stages.

8. A reactor for reacting a hydrocarbon containing reactant stream with oxygen and steam to produce a synthesis gas product stream, said reactor comprising:
a plurality of separate reaction stages for reacting the hydrocarbon containing reactant stream with oxygen and steam in partial oxidation reactions and in steam methane reforming reactions to produce the synthesis gas product stream;
the reaction stages containing catalytic reaction zones having a catalyst to promote the partial oxidation reactions, the catalytic reaction zones being connected in series, separation zones located adjacent to the catalytic reaction zones and oxygen transport membrane elements located between the separation zones and the catalytic reaction zones to separate oxygen from an oxygen containing gas to support the partial oxidation reactions occurring within the catalytic reaction zones;
each of the reaction stages having a housing to contain the catalytic reaction zones, the separation zones, and the oxygen transport membrane elements, the housing having an oxygen gas inlet to introduce the oxygen containing gas into the separation zones, a retentate outlet to discharge an oxygen depleted retentate from the separation zones, a reactant inlet to introduce reactant into the catalytic reaction zones and a product outlet to discharge product produced from the partial oxidation reactions and the steam methane reforming reactions;
the oxygen transport membrane elements having metallic supports and oxygen transport membrane materials supported by the metallic supports; and
the metallic supports of the oxygen transport membrane elements of at least a final of the reaction stages from which the synthesis gas product is discharged being fabricated from oxide dispersed strengthened metal and the metallic supports of the oxygen transport membrane elements of at least one of the reaction stages located upstream of the at least the final of the reaction stages being fabricated from a high temperature metallic material not constituting the oxide dispersed strengthened metal.

9. The reactor of claim 8, wherein:
each of the reaction stages are formed by planar members spaced apart and connected to one another to define the catalytic reaction zones and the separation zones on opposite sides of the planar members; and
the planar members having porous regions and oxygen transport membrane materials located on said porous regions, thereby to form the oxygen transport membrane elements with the planar members serving as the metallic supports.

10. The reactor of claim 9, wherein:
each of the reaction stages have catalytic reaction zones alternating with the separation zones with pairs of spaced planar members forming the oxygen transport membrane elements being located between the catalytic reaction zones and the separation zones being located between the pairs of spaced planar members; and
supports separate the pairs of the planar members.

11. The reactor of claim 10, wherein the supports for the pairs of spaced planar members forming the oxygen transport membrane elements are of serpentine configuration.

12. The reactor of claim 11, wherein the reactor has five of the reaction stages.
